(19) United States
(12) Patent Application Publication
(10) Pub. No.: US 2016/0381558 A1
(43) Pub. Date: Dec. 29, 2016

(54) Policy-Based Protection of Non-Informing Spectrum Operations

(71) Applicant: Jesse M. Caulfield, McLean, VA (US)

(72) Inventor: Jesse M. Caulfield, McLean, VA (US)

(21) Appl. No.: 14/753,059

(22) Filed: Jun. 29, 2015

(51) Int. Cl. H04W 12/08; H04W 16/14; H04L 29/06

(52) U.S. Cl. CPC H04W 12/08; H04L 63/20; H04W 16/14

(57) ABSTRACT

A spectrum access system (SAS) and policy engine (PE) application are provided that facilitates the detection, classification and protection of a non-informing spectrum user in a spectrum sharing environment. The SAS may contain a policy database. Wireless access points with an embedded PE software application may retrieve a spectrum policy configuration specific to their immediate location and capabilities and may use the policy configuration to efficiently detect, classify and protect a non-informing spectrum user from radio frequency interference without disclosing details about the detected spectrum operations.

### CROSS-REFERENCE TO RELATED APPLICATIONS

Not applicable.

### FIELD OF THE INVENTION

The present invention relates generally to spectrum access and administration systems and more particularly to protecting the spectrum operations of a non-informing incumbent user through the use of policy-based signal sensing and classification.

### BACKGROUND OF THE INVENTION

In a wireless communications system an Incumbent User (IU) is generally defined as either a user having primary status over another (e.g. secondary) user or, in the case of co-primary users, a wireless service type having primary status over another (e.g. secondary) service type. It may also occur in certain frequency bands that additional levels of prioritization are established by the regulator, such as, for example, a tertiary, quaternary, quinary, etc. or unlicensed user or service.

To facilitate spectrum sharing and access between incumbent and non-incumbent users a government regulator may designate one or more privately operated Spectrum Access Systems (SAS) to operate as a spectrum sharing authority.

In certain circumstances a incumbent user does not or may not inform the SAS about its spectrum operation and may be called a Non-Informing Incumbent User (NIIU). One solution a SAS may implement to prevent NIIU spectrum operations from receiving radio frequency (RF) interference from other secondary (or lesser) spectrum operations is to establish geographic exclusion zones within which a secondary (or lesser) user may not operate. Another solution a SAS may implement protects NIIU spectrum operations by allowing secondary (or lesser) users to operate within a geographic protection zone only after a SAS positively confirms that the NIIU is not operating. In this context the term “spectrum operations” means some form of transmission of electromagnetic energy in a radio frequency band. The transmission may be, for example, a radar transmission, a digital signal transmission, a analog signal transmission, or any other of a wide variety of radio transmission types, strategies and schemes.

To positively confirm the presence or absence of NIIU spectrum operations a SAS may employ a Environmental Sensing Capability (ESC). In this context the term “Environmental Sensing Capability” means a distributed system of radio frequency sensors; the term “ESC” is therefore not used in this document as a generic capability to detect but rather as the actual system doing the detection. A SAS may employ a ESC to detect NIIU spectrum operations and, upon detection, effect the NIIU's primary spectrum rights against other secondary (or lesser) spectrum users. As an example, in the 3,500-3,750 MHz frequency band the incumbent spectrum user is the U.S. Military, which is non-informing because their spectrum operations are dynamic, non-public and subject to operational security constraints.

While there exists a need to detect and also to protect a NIIU's primary spectrum rights there also exists, for certain classes of NIIU, such as, for example, Federal or Military users, a need to effect the protection in a manner that satisfies the incumbent user's operational security requirements. For example, in protecting NIIU a SAS, through its ESC, may collect and assemble spectrum situational awareness about the NIIU. Similarly through its normal operation a SAS may inadvertently enable a third party to also learn and assemble situational awareness about the NIIU. This spectrum situational awareness information may create an operational security risk for certain NIIU, such as the U.S. Military, for example. A spectrum sharing solution is therefore required that limits the total information available to a SAS while enabling the SAS to execute its designated spectrum administration responsibilities.

### BRIEF SUMMARY OF THE INVENTION

A method is provided to protect the spectrum operations of a non-informing incumbent spectrum user in a manner that limits information about the incumbent user's spectrum operation to only the sensing apparatus.

### BRIEF DESCRIPTION OF THE DRAWINGS

Many aspects of the present disclosure can be better understood with reference to the following drawings. The drawings serve to further illustrate various embodiments and to explain various principles and advantages of the present invention. The components in the drawings are not necessarily to scale, emphasis instead being placed upon clearly illustrating the principles of the disclosure.

FIG. 1 is an exemplary diagram of a ESC supporting of a plurality of SAS instances.

FIG. 2 illustrates an example wireless network configuration.

FIG. 3 illustrates how a dynamic spectrum access policy may be established and applied to certain geographic regions of the United States.

FIG. 4 is an exemplary diagram showing ESC functionality embedded into a plurality of policy-enabled eNodeB wireless access point devices, where the spectrum access policies of each eNodeB are coordinated by a SAS and stored in a spectrum access policy database.

FIG. 5 illustrates an example eNodeB type wireless access point according to this disclosure.

FIG. 6 is a flow diagram and process for a spectrum access policy engine application which may be embedded into a wireless access point to implement the functions of a ESC.

FIG. 7 illustrates an example policy-based wireless network configuration according to this disclosure.

### DETAILED DESCRIPTION OF A PREFERRED EMBODIMENT

As will be demonstrated by the various provided examples the effective implementation of a spectrum sharing strategy where the incumbent user is non-informing will benefit from and may require a ESC method and implementation that effectively protects the non-informing incumbent user (NIIU) while also limiting the distribution of information about the NIIU's spectrum operations.

This disclosure describes a novel method for facilitating spectrum sharing in an environment where information about the NIIU's spectrum operations may be privileged, proprietary or secret. The invention described herein protects a NIIU and the detected information about that user by assigning responsibility to implement protection of NIIU spectrum operations to a embedded spectrum access (SA) policy engine. Responsibility to establish and maintain the SA policy configurations that are implemented by the SA policy engine is assigned to the SAS. By this technique ESC functionality may be distributed and embedded within a plurality of wireless access point devices and the aggregate ESC capability, as implemented by the various wireless access point devices, may cause the NIIU to receive RFI protection without requiring the disclosure of detailed information about the detected NIIU spectrum operations to the SAS or to a third party.

In the described policy-based incumbent protection strategy all detailed information about the detected NIIU's spectrum operations, including for example its immediate geographic location, operating frequency or frequencies, the time of detection, etc. may be kept within the detecting wireless access point device or devices and not distributed or collected in a central repository.

The disclosure and various features and advantageous details thereof are explained more fully with reference to the exemplary embodiments illustrated in the accompanying drawings and detailed in the following description. Descriptions of known programming techniques, computer software, hardware, operating platforms and protocols may be omitted so as not to unnecessarily obscure the disclosure in detail. The detailed description and the specific examples, while indicating the preferred embodiments, are given by way of illustration only and not by way of limitation. Various substitutions, modifications, additions and/or rearrangements within the spirit and/or scope of the underlying invention will become apparent to those skilled in the art from this disclosure.

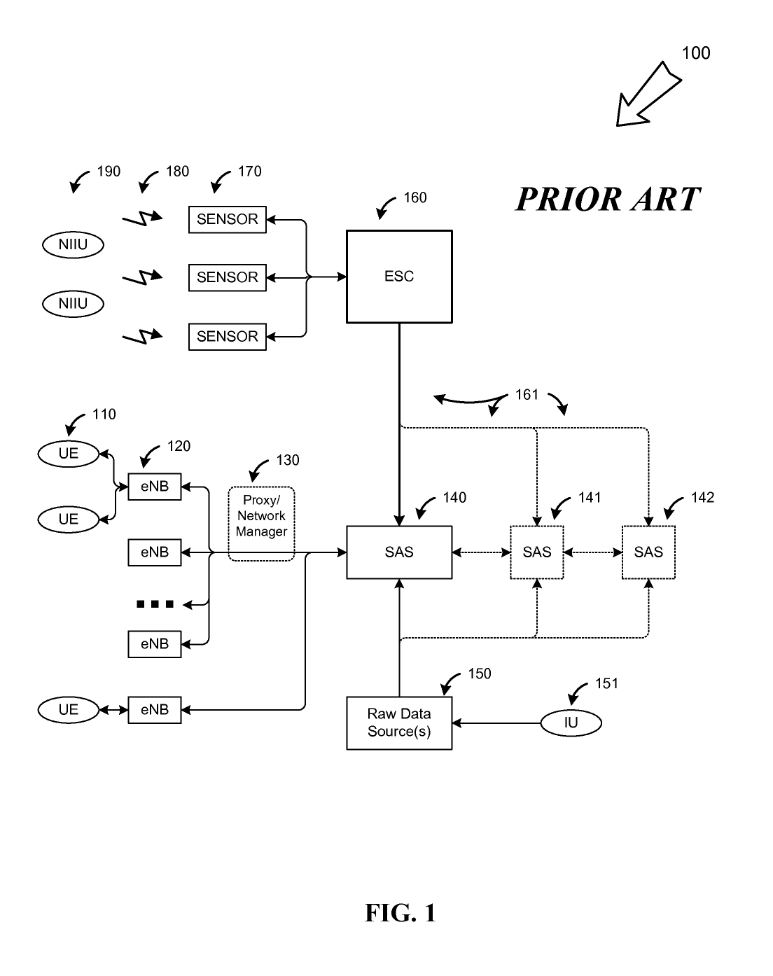

The provided examples are furthermore not intended as restrictions or limits to terms with which they are utilized. Instead the examples or illustrations are intended to describe a particular embodiment for illustrative purposes. Those of ordinary skill in the art will appreciate how the provided examples or illustrations encompass other embodiments and such embodiments are intended to be included within the scope of this invention. Accordingly, FIGS. 1 through 7, discussed below, and the various embodiments used to describe the principles of the present invention in this document are for illustration only and should not be construed as limiting the scope of the disclosure. Those skilled in the art will understand that the principles of this disclosure may be implemented in any suitably arranged device or system.

Referring to FIG. 1 a known concept for a spectrum sharing configuration 100 is shown that incorporates one or more Spectrum Access System (SAS) 140 and a separate Environmental Sensing Capability (ESC) 160. While not shown in the concept diagram it is commonly understood that there may also exist a plurality of ESC implementations.

In a known spectrum sharing configuration 100 one or more SAS implementations 140, 141, 142, etc. may be designated by a government regulator as a spectrum sharing authority for one or more frequency bands. Each SAS instance may receive and processes various raw data 150 from a variety of sources, including the regulator, that includes information sufficient to implement radio frequency interference protection of various informing incumbent users (IU) 151 but not sufficient to protect various NIIU 190.

A user equipment (UE) 110 device may receive wireless service from a plurality of fixed, mobile or transportable eNodeB (eNB) wireless access point devices 120 that may receive a radio frequency allocation or assignment from a SAS 140. For convenience and to facilitate network scalability a plurality of eNB radio frequency allocation or assignment transactions may be aggregated through an optional intermediate Proxy or Network Manager apparatus 130.

For convenience the term “eNodeB” (eNB) refers in this document to network infrastructure components that provide wireless access to remote terminals. Depending on the network type other well-known terms may be used instead of “eNodeB”, such as “access point”, “base station”, etc. Also for convenience the term “user equipment” (UE) refers in this document to a remote device that wirelessly communicates with an eNB, whether the UE is a mobile device (such as a mobile radiotelephone, smart phone, etc.) or is normally considered a stationary device (such as a desktop computer, vending machine, etc.) Other well-known terms may also be used instead of “user equipment” depending on the network type, such as, for example, “mobile station,” “subscriber station,” “remote terminal,” “wireless terminal,” “user device,” “end user device,” etc. The various UE 110 and eNB 120 devices may employ various wireless technologies and protocols, such as, for example, WiFi, WiMAX, LTE, etc. to exploit their radio frequency allocation or assignment.

In a known implementation 100 responsibility for protecting all IU, informing 151 and non-informing 190, may be delegated by the regulator to one or more SAS 140, 141, 142, etc. The purpose of the SAS is to enable wireless UE 100 and eNB 120 devices to gain access to spectrum on a subordinate (e.g. secondary or lesser) basis to the various IU; to ensure those various IU do not receive or experience radio frequency interference (RFI) from the subordinate users (i.e. to “protect” the IU from receiving RFI); and also to facilitate frequency coordination among the various subordinate users to more efficiently exploit the spectrum of a given frequency band.

Referring again to FIG. 1 the purpose of a ESC 160 is to detect the spectrum operations 180 of a NIIU 190 and to provide information about the detected NIIU to a SAS 140, 141, 142 so that the SAS may execute its responsibilities.

ESC configurations may consist of a plurality of centralized servers 160 tasked with data collection, data storage, data processing, etc. and a geographically distributed configuration of multiple and various spectrum sensing devices 170, such as, for example, spectrum analyzers, radio frequency tuners, etc. that are each configured to detect and identify the radio frequency emissions 180 of a plurality NIIU 190. Other ESC configurations are also known including, for example, a centralized management and messaging capability 160 with data collection, storage, processing, etc. functions distributed into the various spectrum sensing devices 170.

The one or more SAS implementations 140, 141, 142, etc. may be configured to communicate with a ESC 160 to receive information about the detected NIIU 190 using a communications protocol 161, the information being sufficient for the SAS to execute its responsibilities.

The current invention extends the known implementation 100 in a novel and unique manner by first partitioning the NIIU protection responsibilities of the SAS, embedding ESC functionality into a eNB device, and directing the eNB device to detect and protect the spectrum operations of a non-informing IU according to policy directives provided by the SAS.

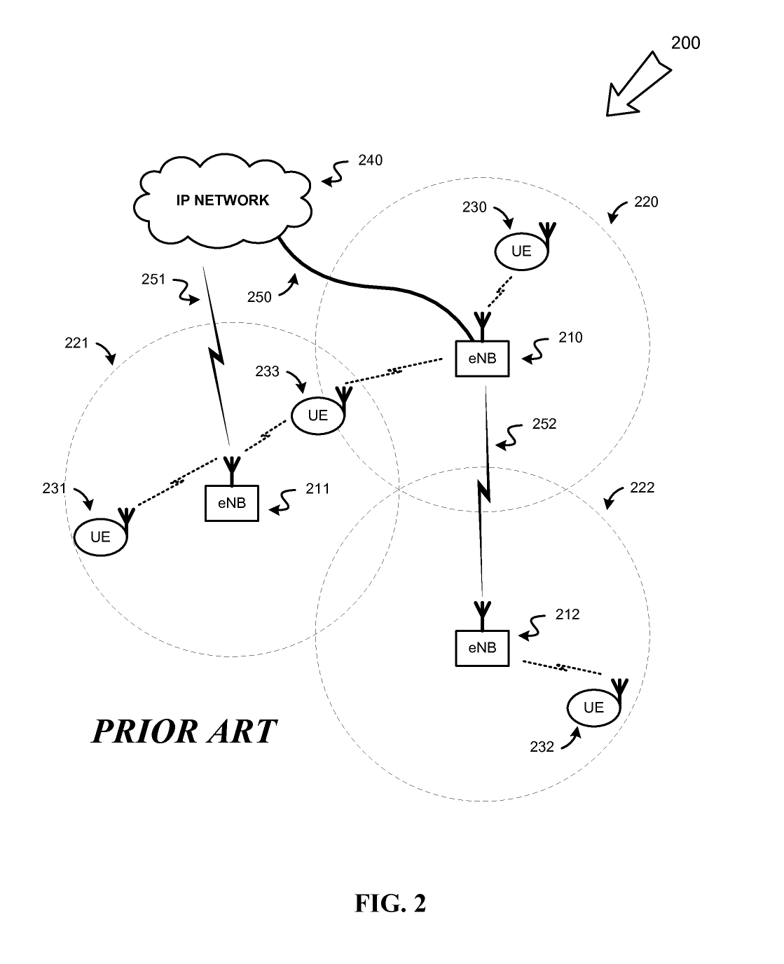

FIG. 2 illustrates an example wireless network. The exemplar wireless network 200 may include a plurality of eNodeB (eNB) wireless access points 210, 211, 212, etc. According to a typical configuration each eNB may communicate with another eNB directly or indirectly via a terrestrial 250 (e.g. fiber, copper, etc.) or wireless 251, 252 (e.g. microwave) communication link and also communicate with a Internet Protocol (IP) network 240 (e.g. the Internet, a private network, etc.)

According to a typical embodiment a eNB 210 may provide wireless access to a network 240 for a first plurality of user equipment (UE) 230, 233 within the radio service area 220 of the eNB 210. Other eNBs 211, 212 may provide wireless access services to other pluralities of UE 231, 232, 233 within their respective radio service areas 221, 222, and a mobile UE 233 may move from one radio service area 220 to another 221 and temporarily receive simultaneous wireless access service from two eNBs 210, 211 during the transition.

Referring again to FIG. 2 the eNB radio service areas 220, 221, 222 are shown as having approximately circular geographic extent. One skilled in the art will know that actual radio service areas may be irregular and depend upon the configuration of the eNB, the configuration of the eNB antennae, variations in the radio environment from natural and man-made obstructions, and other factors.

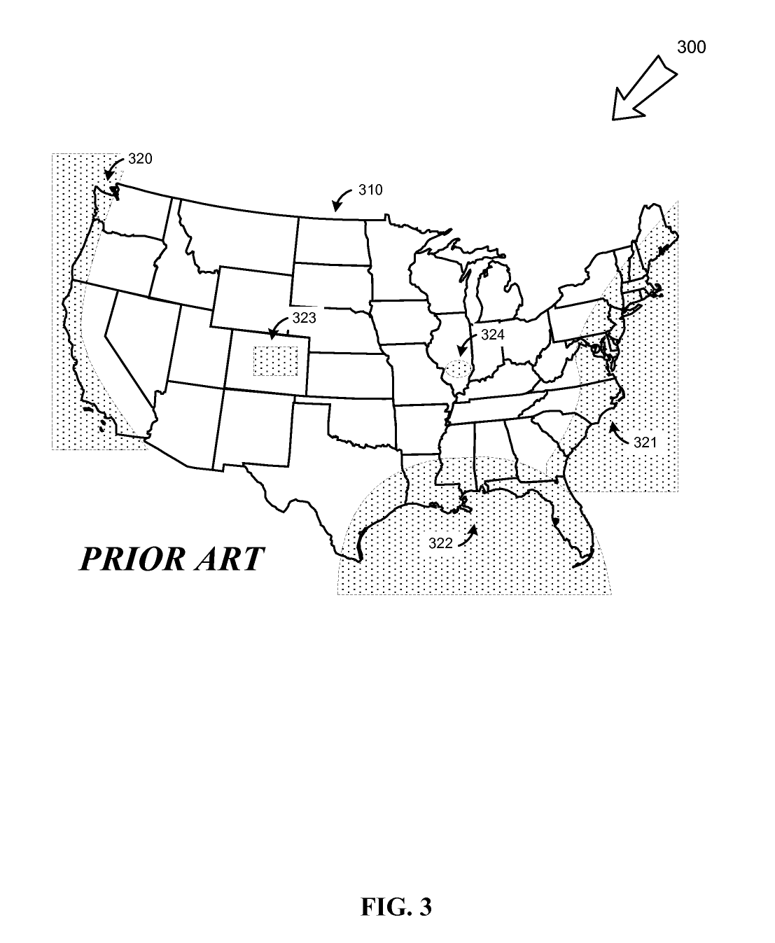

In FIG. 3 a example geographic spectrum access policy configuration is shown. An example configuration 300 is provided wherein a SAS may be designated and authorized to provide spectrum administration services within a national boundary 310. It is well known that a government regulator's authority over spectrum access may extend to the sovereign boundaries of the regulator's jurisdiction 310 and that a regulator may establish various geographic regions 320, 321, 322, 323, 324, etc. within which its jurisdiction where the regulator may require different spectrum access (SA) policies to be implemented. The established geographic regions may be statically defined (e.g. by a set of fixed coordinates) or dynamically defined (e.g. by a prescribed calculation methodology).

Accordingly, the geographic extent to which a SAS may provide spectrum administration services may also be limited to the sovereign boundary and jurisdiction of the country within which the SAS is operating. Furthermore, operation of a SAS within certain geographic regions of a national jurisdiction may be contingent upon the implementation of various SA policies and, according to an envisioned embodiment, inside each of the various geographic regions the implementation of one or more SA policies may be required to conduct non-incumbent spectrum operations in a specific radio frequency band.

Various SA policies are known. For example, a “sense-and-avoid” policy first attempts to sense an existing signal within a specific radio frequency channel. If a signal is detected then the sensing device does not transmit in the occupied radio frequency channel but instead attempts to find another. A “classify-and-avoid” SA policy is similar to “sense-and-avoid” except that the detected signal is also analyzed and classified to establish the detected signal type, its incumbent / non-incumbent status and prioritization. After classification the sensing device may then optionally begin transmitting on the occupied channel, presumably forcing a lower priority user to vacate the channel, or select another channel, according to the specific SA policy configuration.

For example, in the 3,500-3,750 MHz radio frequency band the government regulator (NTIA and FCC jointly) has established a collection of geographic exclusion zones within which a non-incumbent spectrum user must implement a “sense-and-avoid” SA policy, wherein a NIIU's spectrum operations must be detected and, if detected, must be avoided. Conversely, outside of the geographic exclusion zones the “sense-and-avoid” policy may not be in effect.

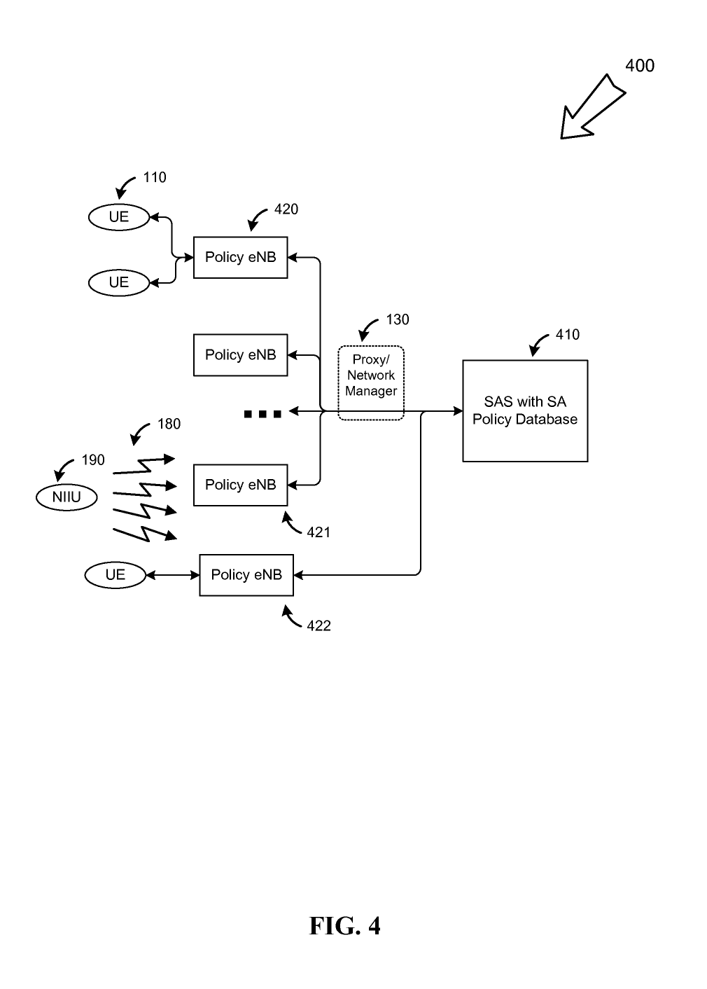

Referring to FIG. 4 the spectrum sharing configuration of FIG. 1 is revised to incorporate eNB wireless access devices that are capable of internally implementing a spectrum access SA policy. The spectrum sharing configuration 400 shown in FIG. 4, which is described in conjunction with FIG. 1 and FIG. 3, includes a conventional SAS that has been extended to include a database of SA policy configurations 410. According to a preferred embodiment, the various SA policy configuration records stored within the SA policy database 410 may include the geographic extent of their applicability. Additionally, according to an envisioned embodiment the SA policy database may contain, for example, a “sense-and-avoid” SA policy configuration for some geographic regions 323, 324 and another “classify-and-avoid” SA policy configuration for some other geographic regions 320, 321, 322.

In the context of this disclosure a radio frequency (RF) signal fingerprint is a machine-readable description of a RF signal's technical parameters, metrics, characteristics and behavior that may be used to efficiently identify and classify a type of RF signal from empirically measures spectrum data. Referring again to FIG. 4 the SA-enabled eNB 420 may receive and implement one or more policy configurations from the SAS 410. The received policy configurations may include a RF signal fingerprint of other non-incumbent signals in the immediate region that the eNB may encounter during normal operation. The received policy configuration may also include RF fingerprints of NIIU signals the eNB may expect to encounter and detect, along with instructions the eNB must execute upon NIIU signal detection. For example, a SAS 410 may provide a policy-enabled eNB 420 that is not located in a geographic policy region with an empty policy configuration and thereby permit the eNB 420 to operate without sensing. A SAS 410 may also provide other policy-enabled eNB 421, 422 that are located within a geographic policy region with a “classify-and-avoid” SA policy configuration that also includes an RF signal fingerprint of the type or types of NIIU signals 180 that must be avoided.

The use of RF signal fingerprints to inform a policy-enabled eNB about the types of signals it must look for may significantly improve the eNB's signal detection efficiency and accuracy. Generalized signal detection and classification algorithms can be very complex and require significant computing resources. However, known signal identification and classification is a much simpler task and may be more readily implemented on an eNB, which is typically a resource-constrained system.

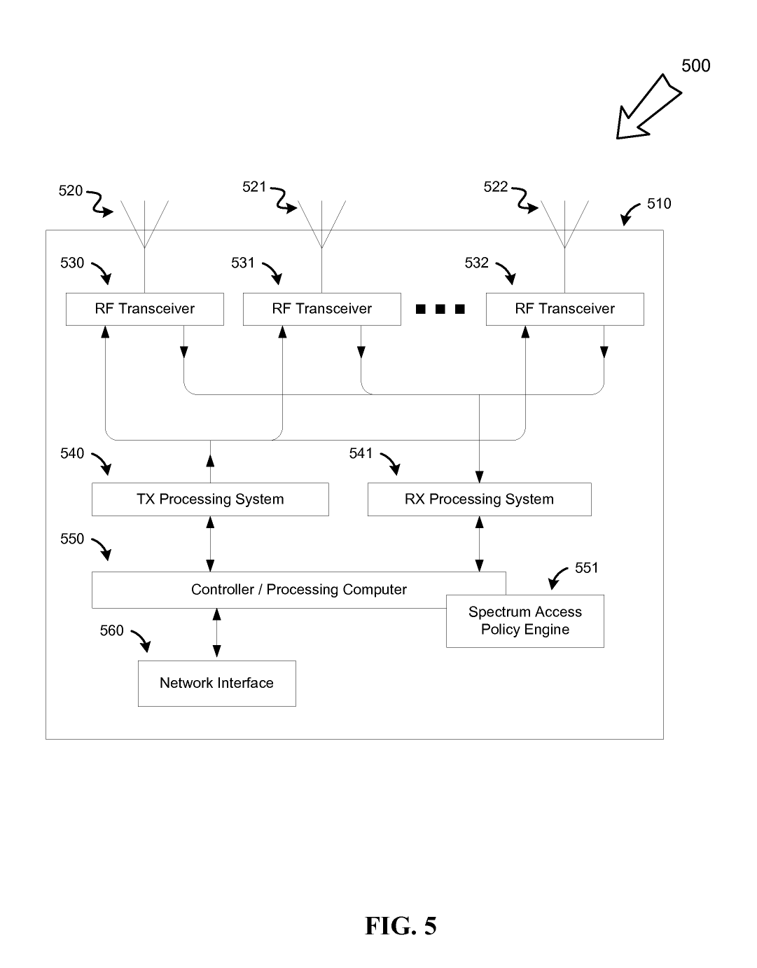

FIG. 5 illustrates a typical eNB according to this disclosure. A typical eNB 500 may support spectrum operations on a variety of radio frequency (RF) bands. To transmit and receive wireless communications on the RF bands with a plurality of user equipment (UE) the exemplar eNB 510 may include multiple antennas 520, 521, 522, etc. and multiple RF transceivers 530, 531, 532, etc. each connected to a transmit (TX) signal processing system 540 and a receive (RX) signal processing system 541. The TX processing system 540 and RX processing system 541 may be implemented in an application-specific integrated circuit (ASIC), a field-programmable gate array (FPGA), a general purpose computing processor, or some combination thereof. An exemplar eNB 510 also includes a controller / processing computer (computer) 550 capable of storing and executing various software applications. For example, one software application executed on the computer 550 performs data routing and forwarding between the TX and RX processing systems 540, 541 and a network interface 560. The network interface 560 enables the eNB 510 to communicate with other devices or systems over a external, wide-area or backhaul network. The network interface 560 may support communications over any suitable wired or wireless infrastructure, such as an Ethernet or an RF transceiver. For example, in conjunction with FIG. 2, when a eNB is implemented as part of a cellular communication system (such as one supporting 3G, 4G, 5G, LTE, etc), the interface 560 could allow a eNB 212 to communicate with another eNB 210 over a wireless backhaul connection 252 and a eNB 210 to communicate with an IP network over a wired backhaul connection 250. If a eNB is configured as an access point the interface 560 could allow the eNB 211 to communicate over a wired or wireless connection 251 to a larger network such as the Internet 240.

Referring again to FIG. 5 and FIG. 2 collectively, the RF transceivers 530, 531, 532, etc. receive, from the antennas 520, 521, 522, etc., incoming RF signals such as, for example, signals transmitted by a plurality of UEs 230, 231, etc. located within the eNB service region 220. The RF transceivers 530, 531, 532, etc. down-convert the incoming RF signals to generate intermediate frequency (IF, also colloquially called “baseband”) signals. Received IF signals are routed from the RF transceivers to the RX processing system 541, which filters, decodes, and digitizes the down converted IF signals then transmits the received digital signal information to the computer 550 for further processing.

The TX processing system 540 may receive digital data such as, for example, a digitized voice stream or non-streaming packetized data from the computer 550, which may have received the digital data from the network interface 550 or from the RX processing system 541 or may originate the data itself from a local application. The TX processing system 540 encodes, multiplexes and modulates the digital data into an outgoing IF signal and selects which of the one or more RF transceivers 530, 531, 532, etc. to route the IF data to. The selected one or more RF transceivers 530, 531, 532, etc., which up-convert the IF signal to an RF signal and transmit the RF signal via the one or more antennas 520, 521, 522, etc.

The computer 550 may include one or more general purpose processors or other processing devices that control the overall operation of the eNB 510. For example, the computer 550 may control the reception of forward channel signals and the transmission of reverse channel signals by the RF transceivers 530, 531, 532, etc. and the TX and RX processing systems 540, 541 in accordance with well-known principles. The computer 550 may also support more advanced wireless communication functions. For instance, the computer 550 may support beam forming and directional routing algorithms in which outgoing signals from multiple antennas 520, 521, 522, etc. are weighted differently to effectively steer the outgoing signals in a desired direction. The computer 550 may also support multi-band spectrum operations, where the multiple antennas are tuned to different RF bands of the electromagnetic spectrum and the eNB communicates with UE on those different RF bands, singularly or simultaneously, multiplexing across more than one RF band at a time.

According to a typical embodiment a eNB 510 may implement a single duplex wireless transmission path consisting of a antenna 520 and RF transceiver 530 tuned to a licensed RF band, such as, for example, LTE Band 3. The same eNB 510 may also implement a second duplex wireless transmission path consisting of a separate antenna 521 and RF transceiver 531 tuned to a unlicensed RF band, such as, for example, the 802.11g ISM band between 2,400 and 2,500 MHz. According to a preferred embodiment an eNB 510 may furthermore implement a single duplex wireless transmission path consisting of a antenna 522 and RF transceiver 532 tuned to a SAS-administered RF band, such as, for example, the 3,500-3,750 MHz band.

Referring again to FIG. 5, in a typical eNB 500 the computer 550 includes at least one microprocessor or microcontroller, volatile memory such as RAM and non-volatile, persistent storage such as FLASH, ROM, or a hard drive. The computer 500 is also capable of loading and executing programs and other processes resident in its memory such as an operating system and any of a wide variety of other software application.

According to a preferred eNB embodiment a SA policy engine (PE) application 551 may be executed on the computer 550, and the PE application 551 may also be configured via a set of variable parameters. The PE configuration parameters may be located and loaded by the computer 550 from non-volatile memory, a local hard-drive or another information storage and retrieval resource such as, for example, a web service provided by a SAS. The PE configuration parameters may be contained in a file, in a database record, in one or more electronic messages, or in another machine readable format. In a preferred embodiment the computer 550 may be configured to route digital signal information received from a RX processing system 541 to the PE application 551, which may analyze and attempt to classify the received digital signal information. For example, the PE application 551 may be loaded by the computer 550 with a PE configuration that contains one or more RF signal fingerprints identifying various unique characteristics of one or more NIIU radio signals. The PE application 551 may, when executed by the computer 550 with a specific SA policy configuration for example, ignore all received signals that do not match the PE configured RF signal fingerprints. The PE application 551 may additionally be configured to trigger a detection event when a received signal does match the PE configured RF signal fingerprint. Upon detection the PE application 551 may furthermore be configured to cause the computer 510 to take a series of prescribed actions, such as ceasing transmission in the radio frequency channel or band in which a signal fingerprint match was detected.

Although FIG. 5 illustrates a typical eNB 500 implementation various changes may be made to accomplish the described functionality. For example, the eNB 510 could include any number of each component such as multiple interfaces 560, multiple TX and RX processing systems 540, 541, multiple computers 550, etc. Similarly, various components in the exemplar 500 could be combined, further subdivided, or omitted and additional components could be added. Various other signal filtering, routing and amplification steps are omitted from the exemplar system 500 and the description for clarity. One skilled in the art will recognize that eNBs are commercially available in a variety of configurations and that the exemplar in FIG. 5 does not limit the scope of this disclosure to any particular implementation of an eNB.

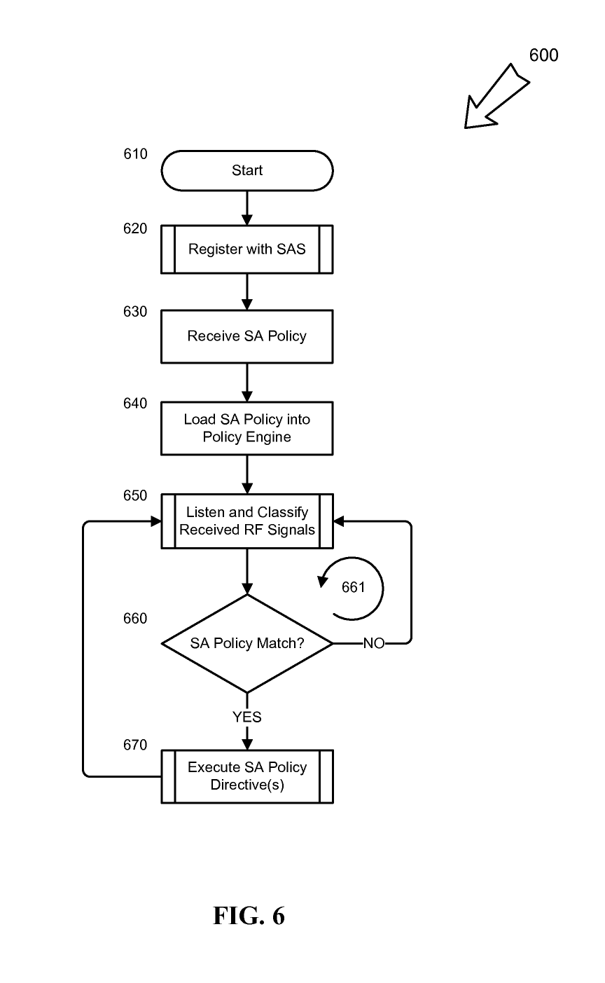

Referring to FIG. 6 an exemplary process is provided that a policy-enabled, multi-band eNB may follow to establish wireless network services on a radio frequency band that is administered by a SAS. The process 600 is described in conjunction with elements of FIGS. 4 and FIG. 5 and includes: Starting with eNB initialization 610 the eNB 420 may register itself with a spectrum access system 410. Registration may include transmitting, from the eNB 420 to the SAS 410, information about the eNB including the RF transceiver 530, 531, 532, etc. frequency ranges, the eNB physical location (e.g. latitude, longitude, height above ground, etc.), the eNB computer capabilities (e.g. processor and memory capacity, operating system, software versions, etc.) and whether the eNB computer 550 is executing, or has the capability to download and execute, a PE application 551. According to a preferred embodiment successful registration with a SAS will require at least that the eNB have a RF transceiver 530, 531, 532, etc. capable of operating in a frequency band administered by the SAS and is either executing or can execute a PE application 551.

Following successful registration the eNB 420 may receive from the SAS 410 a SA policy configuration 630. The SA policy configuration may be a file, a message, a sequence of messages, or other machine readable information exchange. Upon receipt the eNB computer 550 may then load the SA policy configuration into a PE application 640, 551. Once the SA policy configuration is loaded into a PE application the eNB computer 550 may then forward received signal information to the PE application for analysis and classification 650. If the received signal information does not match any configured SA policy the eNB may establish or maintain a wireless network on the SAS-administered frequency band or bands and continue NIIU sensing indefinitely 661. Conversely, if a PE application does identify a RF signal fingerprint match with the received signal information the PE may trigger a detection event to the computer 550 and cause the computer 550 to execute the directives in the matched SA policy configuration 670. For example, a SA policy configuration may instruct the eNB to immediately cease transmission on a specific frequency band. Another SA policy configuration may instruct the eNB to migrate users to another frequency band within a specified period of time. Another SA policy configuration may instruct the eNB to continue monitoring on the detected frequency band for a period of time to classify the detected signal with high confidence. Another SA policy configuration may instruct the eNB to notify a SAS of the detection event.

Referring again to FIG. 6, a typical policy-enabled eNB may be configured during installation, at the factory or through the normal course of operation with a default SA policy that the eNB may use when, for example, a SAS is unavailable or unreachable. In the immediate circumstance it will be obvious to one skilled in the art that a policy-enabled eNB may skip steps 620, 630 if required, load a default SA policy 630 if available, and proceed to implement the exemplary process 600.

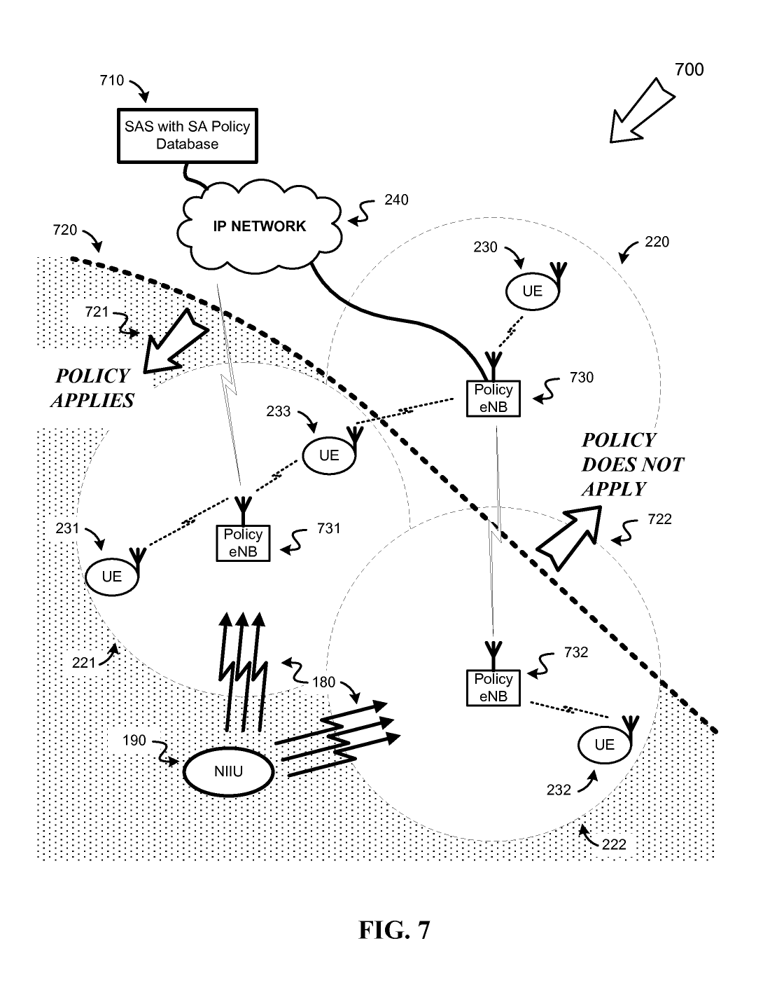

Referring to FIG. 7 the benefit of a SAS plus SA policy database may be immediately recognized. According to an envisioned embodiment a wireless network 700, shown in FIG. 7 and described in conjunction with elements of FIG. 1, FIG. 2 and FIG. 3, may be comprised of a plurality of geographically distributed policy-enabled eNB wireless access point devices 730, 731, 732, etc. each providing wireless services to various pluralities of user equipment (UE) 230, 231, 232, 233, etc. located within each eNB's respective service area 220, 221, 222, etc. Each eNB installation may be configured to operate across multiple RF bands that include RF bands administered by a SAS. Furthermore, the various eNB may be installed in geographic regions requiring the application of a SA policy. In the exemplar wireless network 700 a NIIU “classify-and-avoid” policy may be required for eNB operation on one side of a geographic border 720 and within a defined geographic region 721. In a preferred embodiment the various eNB 211, 212, etc. located within the “policy applies” geographic region 721 must first register with a SAS 710 and operate according to the previously describe process 600. In the example wireless network 700 the SAS SA policy configuration may include a radio signal fingerprint of the NIIU signal emission 180 plus steps to be taken upon detection of NIIU spectrum operations, such as, for example, vacating the NIIU-occupied spectrum and notifying the SAS of the NIIU detection event.

Referring again to FIG. 7 a blank or empty SA policy configuration may be provided to the various eNB 210, etc. installed on the other side of a geographic border 720 and within a “policy does not apply” geographic region 722 or, conversely, not within a “policy applies” region. In this circumstance the blank or empty SA policy configuration may specify a geographic area and no RF signal fingerprint, for example. Any NIIU signal information 180, if detected, would therefore not match the blank SA policy configuration nor cause the execution of an associated SA policy directive in the specific eNB 730.

It is now appreciated how a SAS, when supplemented with a SA policy database, may enable policy-enabled eNB devices to implement the functions of a ESC to protect NIIU spectrum operations without disclosing information about the detected spectrum operations. According to the described system and method the ESC functionality is embedded into a plurality of eNB devices which individually are each responsible to detect, classify and protect NIIU spectrum operations from non-incumbent radio frequency interference. A SAS establishes and manages the policy configurations necessary to implement the actual protection. The described method purposefully limits information about the detected NIIU spectrum operations to the detecting apparatus and, inside the apparatus, to within a SA policy engine application. Only the detection event is available outside the PE software application. The distributed solution inherently includes a greater degree of information security and may be useful in circumstances where the IU does not or may not inform the SAS about its spectrum operations, and where information about the IU may be considered protected, non-public or secret and subject to operational security constraints.

Although a variety of examples and other information was used to explain aspects within the scope of the appended claims no limitation of the claims should be implied based on particular features or arrangements in such examples as one of ordinary skill would be able to use these examples to derive a wide variety of implementations. Although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

A variety of implementations of the invention have been described. Nevertheless it is expected that various modifications may be introduced without departing from the spirit and scope of the invention. For example, the SA policy engine may be implemented in software on a general purpose processor, as hardware instructions on a FPGA or encoded into an ASIC; a SA policy configuration may be stored locally on the eNB instead of retrieved from a SAS, and a SA policy engine may be configured to operate without a separate configuration. Accordingly, other embodiments are within the scope of the following claims.

1. A system for protecting the spectrum operations of a non-informing user, comprising:
a. a spectrum access system configured to access a database; the database being configured to contain a plurality of spectrum access policy configurations; where
i. each of the individual policy configurations includes a radio frequency signal fingerprint, wherein a fingerprint consists of various technical parameters and metrics that may be used to more efficiently classify a specific type of radio frequency signal; and
ii. each of the individual policy configurations identifies a geographic region where the policy configuration is applicable; and
b. a plurality of policy-enabled wireless access point devices, each of the plurality of devices being configured to:
i. identify its geographic position; and
ii. execute a spectrum access policy engine application; and
iii. load the policy engine application with one or more policy configurations that each are applicable to the specific device's geographic location; and
c. a spectrum access policy engine application; where
i. the policy engine application is capable of loading and operating in accordance with instructions contained within at least one policy configuration; and
ii. the policy engine application may continuously receive radio frequency signal information, compare the received signal information against at least one policy configuration and, if the received signal information matches the radio frequency signal fingerprint of a policy configuration, the policy engine application may cause the device executing the policy engine application to take at least one or more action prescribed in the matched policy configuration.

2. The system of claim 1 where the spectrum access policy configuration is retrieved from a spectrum access system.

3. The system of claim 1 where a default spectrum access policy configuration is built in to the spectrum access policy engine application.

4. The system of claim 1 where a default spectrum access policy configuration is loaded by the spectrum access policy engine application.

5. The system of claim 1 where the spectrum access policy engine application causes the executing device to change the radio frequency channel of transmission.

6. The system of claim 1 where the spectrum access policy engine application causes the executing device to cease transmitting on a radio frequency channel.

7. The system of claim 1 where the spectrum access policy engine application causes the executing device to notify a spectrum access system of the detection event.

8. A method for protecting a non-informing spectrum user, comprising:
a. establishing a plurality of spectrum access policy configurations; each policy configuration containing:
i. a geographic area within which the policy is effective;
ii. a radio frequency band for which the policy is effective;
iii. a radio frequency signal fingerprint describing the type of radio frequency signal for which the policy is effective;
iv. one or more instructions to be executed when the policy configuration is implemented; and
b. storing the plurality of spectrum access policies in a database; and
c. retrieving one or more policy configurations by a policy-enabled wireless access point device; and
d. loading one or more policy configurations into a policy engine, where the policy engine is executed by a policy-enabled wireless access point device; and
e. within the policy engine:
i. continuously comparing received radio frequency signal information against the various radio frequency signal fingerprints described in the one or more policy configurations; and
ii. taking no action if the received radio frequency signal information does not match the radio frequency signal fingerprint in any loaded policy configuration; or
iii. if the received radio frequency signal information does match the radio frequency signal fingerprint of a specific policy configuration, causing the wireless access point device to implement the matched policy configuration and thereby execute the one or more instructions contained therein.

9. The method of claim 8, where the one or more policy configurations are loaded according to a calculation that includes the geographic area of each respective policy configuration and the immediate geographic position of the wireless access point device.

10. The method of claim 8, where the one or more policy configurations are loaded according to a comparison of the policy configuration and the radio frequency bands supported by the wireless access point device.

11. The method of claim 8, where a policy configuration does not include a radio frequency signal fingerprint and is interpreted by the policy engine to not match any type of received radio frequency signal information.

12. The method of claim 8, where a policy configuration does not include a radio frequency signal fingerprint and is interpreted by the policy engine to match every type of received radio frequency signal information.

13. The method of claim 8, where:
a. the database is associated with a spectrum access system; and
b. the one or more policy configurations are retrieved from a spectrum access system.

14. The method of claim 13, where the spectrum access system filters the available policy configurations to match the immediate geographic position of the requesting policy-enabled wireless access point device.

1. The method of claim 13, where the spectrum access system filters the available policy configurations to match the radio frequency bands supported by the requesting wireless access point device
